(19) United States
(12) Patent Application Publication
(10) Pub. No.: US 2013/0305986 A1
(43) Pub. Date: Nov. 21, 2013

(54) Liquid Crystal Suction Device and Liquid Crystal Coating Equipment

(71) Applicant: Wenching Tsai, Shenzhen (CN)

(72) Inventor: Wenching Tsai, Shenzhen (CN)

(21) Appl. No.: 13/519,314

(22) PCT Filed: May 31, 2012
(86) PCT No.: PCT/CN2012/076313

§ 371 Date: Jun. 26, 2012

(30) Foreign Application Priority Data
May 18, 2012 (CN) 201210156762.1

(51) Int. Cl. B05B 15/00; F17D 3/00

(52) U.S. Cl. 118/300; 137/386

(57) ABSTRACT

The present invention provides a liquid crystal suction device, which includes: a first vacuum generation unit, a flexible suction tube, and a load; the load being disposed at one end of flexible suction tube, the other end of flexible suction tube connected to first vacuum unit. The present invention also provides a liquid crystal coating equipment. Through the above manners, the present invention keeps liquid crystal suction end stay below liquid crystal level and prevents suction end of the liquid crystal tube from drawing in air bubble.

### BACKGROUND OF THE INVENTION

1. Field of the Invention

The present invention relates to the field of liquid crystal displaying techniques, and in particular to a liquid crystal suction device and a liquid crystal coating equipment.

2. The Related Arts

Liquid crystal display device includes thin film transistor (TFT) array substrate, color filter (CF) substrate, and liquid crystal layer sandwiched between TFT array substrate and CF substrate. Liquid crystal display device controls voltage applied to the liquid crystal layer in each pixel to allow the light to change the amount of light transmittance to general images.

Formation of liquid crystal layer is often performed by liquid crystal coating. Liquid crystal coating usually includes using a plurality of liquid crystal drops corresponding to standard liquid crystal quantity to coat a specific amount of liquid crystal to each of the panel areas confined to TFT array substrate or CF substrate. This process usually employs liquid crystal dispenser to dispense liquid crystal onto corresponding areas. Weight and location of each drop of dispensed liquid crystal must be precisely controlled. Refer to FIG. 1 and FIG. 2. Liquid crystal dispenser includes a tube 2 and a pump 3. One end of tube 2 is connected to pump 3, and the other end is suction end 21, and is placed into a liquid crystal container 1. Tube 2 is a flexible tube.

Liquid crystal dispenser uses liquid crystal drawn from purchased liquid crystal container 1, and pump 3 pumps out a fixed volume of liquid crystal drops (in weight). Volume of each liquid crystal drop must be strictly controlled because air is also a compressible fluid. If air bubble appears in liquid crystal before pump 3 pumps out, the situation where liquid crystal drops may have an abnormal volume or even liquid crystal cannot be pumped out. All the above situations will pose potential quality risk or even create defect products.

To avoid the above problem, the know liquid crystal usually is processed with low pressure degas process to rid off the air bubbles in the liquid crystal. However, the known liquid crystal tube may still draw air from the liquid crystal container. Refer to FIG. 1 and FIG. 2. When liquid crystal 4 stored in liquid crystal container 1 is too little, tube 2 is too long (as shown in FIG. 1) or tube 2 is bended (as shown in FIG. 2), suction end 21 of tube 2 stays above the liquid crystal level 5, which results in tube 2 draws air.

### SUMMARY OF THE INVENTION

The technical issue to be addressed by the present invention is to provide a liquid crystal suction device and liquid coating equipment, which keeps suction end of liquid crystal tube always under liquid crystal level to prevent suction end of liquid crystal tube draw in air bubbles.

The present invention provides a liquid crystal suction device, which comprises: a first vacuum generation unit, a flexible suction tube, a load, and an air fitter unit; the load being disposed at one end of flexible suction tube, the other end of flexible suction tube connected to first vacuum unit; the air filter unit being disposed in tube passage of the flexible suction tube, comprising liquid crystal container, second vacuum generation unit and liquid level detection unit; a part of the flexible suction tube being disposed through container opening into container, and the part disposed inside the container being cut so that flexible suction tube being divided into a first suction tube part connected to the first vacuum generation unit and a second suction tube part connected to the load; the second vacuum generation unit being disposed at the second suction tube part, cut point of flexible suction tube being immersed in liquid crystal inside container, when the liquid level detection unit detecting liquid crystal inside the container having a level lower than a first threshold, the second vacuum generation unit being made to draw liquid crystal into container and stopping drawing liquid crystal when the liquid level detection unit detecting liquid crystal inside the container having a level reaching a second threshold, the second threshold being higher than the first threshold, and the load being an object with surface made of glass or stainless steel.

According to a preferred embodiment of the present invention, the load further comprises two intersecting surfaces, with opening of one end of flexible suction tube disposed on one of surfaces of the load, and surface of the load having opening groove, one end of the opening groove connected to opening of one end of flexible suction tube, and other end of opening groove connected to the other surface of the load.

According to a preferred embodiment of the present invention, shape of the load is a sphere, cone or cylinder.

The present invention provides a liquid crystal suction device, which comprises: a first vacuum generation unit, a flexible suction tube, and a load; the load being disposed at one end of flexible suction tube, the other end of flexible suction tube connected to first vacuum unit.

According to a preferred embodiment of the present invention, the load is an object with surface made of glass or stainless steel.

According to a preferred embodiment of the present invention, the load further comprises two intersecting surfaces, with opening of one end of flexible suction tube disposed on one of surfaces of the load, and surface of the load having opening groove, one end of the opening groove connected to opening of one end of flexible suction tube, and other end of opening groove connected to the other surface of the load.

According to a preferred embodiment of the present invention, shape of the load is a sphere, cone or cylinder.

According to a preferred embodiment of the present invention, the liquid crystal suction device further comprises air filter unit, and the air filter unit being disposed in tube passage of the flexible suction tube, comprising liquid crystal container, second vacuum generation unit and liquid level detection unit; a part of the flexible suction tube being disposed through container opening into container, and the part disposed inside the container being cut so that flexible suction tube being divided into a first suction tube part connected to the first vacuum generation unit and a second suction tube part connected to the load; the second vacuum generation unit being disposed at the second suction tube part, cut point of flexible suction tube being immersed in liquid crystal inside container, when the liquid level detection unit detecting liquid crystal inside the container having a level lower than a first threshold, the second vacuum generation unit being made to draw liquid crystal into container and stopping drawing liquid crystal when the liquid level detection unit detecting liquid crystal inside the container having a level reaching a second threshold, the second threshold being higher than the first threshold.

The present invention provides a liquid crystal coating equipment, which comprises: coating head and liquid crystal suction device; wherein the liquid crystal suction device comprises: a first vacuum generation unit, a flexible suction tube, and a load; the load being disposed at one end of flexible suction tube, the other end of flexible suction tube connected to first vacuum unit, the coating head connected to the first vacuum generation unit.

According to a preferred embodiment of the present invention, the load is an object with surface made of glass or stainless steel.

According to a preferred embodiment of the present invention, the load further comprises two intersecting surfaces, with opening of one end of flexible suction tube disposed on one of surfaces of the load, and surface of the load having opening groove, one end of the opening groove connected to opening of one end of flexible suction tube, and other end of opening groove connected to the other surface of the load.

According to a preferred embodiment of the present invention, shape of the load is a sphere, cone or cylinder.

According to a preferred embodiment of the present invention, the liquid crystal suction device further comprises air fitter unit, and the air filter unit being disposed in tube passage of the flexible suction tube, comprising liquid crystal container, second vacuum generation unit and liquid level detection unit; a part of the flexible suction tube being disposed through container opening into container, and the part disposed inside the container being cut so that flexible suction tube being divided into a first suction tube part connected to the first vacuum generation unit and a second suction tube part connected to the load; the second vacuum generation unit being disposed at the second suction tube part, cut point of flexible suction tube being immersed in liquid crystal inside container, when the liquid level detection unit detecting liquid crystal inside the container having a level lower than a first threshold, the second vacuum generation unit being made to draw liquid crystal into container and stopping drawing liquid crystal when the liquid level detection unit detecting liquid crystal inside the container having a level reaching a second threshold, the second threshold being higher than the first threshold.

The efficacy of the present invention is that to be distinguished from the state of the art. The device of the present invention includes a first vacuum generation unit, a flexible suction tube and a load; wherein the load is disposed at one end of the flexible suction tube to keep one end of the flexible suction unit to say below the liquid crystal level. In this manner, the present invention prevents suction end of the liquid crystal tube from drawing in air bubble and keep each liquid crystal drop the same weight.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the tube too long in a liquid crystal dispenser of a known technique;

FIG. 2 is a schematic view showing the tube bended in a liquid crystal dispenser of a known technique;

FIG. 3 is a schematic view showing the structure of the first embodiment of the liquid crystal suction device according to the present invention;

FIG. 4 is a schematic enlarged view showing a conic load of the first embodiment of the liquid crystal suction device according to the present invention;

FIG. 5 is a schematic view showing the load of FIG. 4 upside down;

FIG. 6 is a schematic enlarged view showing a reverse conic load of another embodiment of the liquid crystal suction device according to the present invention;

FIG. 7 is a schematic view showing the load of FIG. 6 upside down;

FIG. 8 is a schematic enlarged view showing a spherical load of another embodiment of the liquid crystal suction device according to the present invention;

FIG. 9 is a schematic view showing the load of FIG. 8 upside down;

FIG. 10 is a schematic enlarged view showing a cylindered load of another embodiment of the liquid crystal suction device according to the present invention;

FIG. 11 is a schematic view showing the load of FIG. 10 upside down;

FIG. 12 is a schematic view showing the structure of the second embodiment of the liquid crystal suction device according to the present invention;

FIG. 13 is a schematic view showing the structure of the first embodiment of the liquid crystal coating equipment according to the present invention; and

FIG. 14 is a schematic view showing the structure of the second embodiment of the liquid crystal coating equipment according to the present invention.

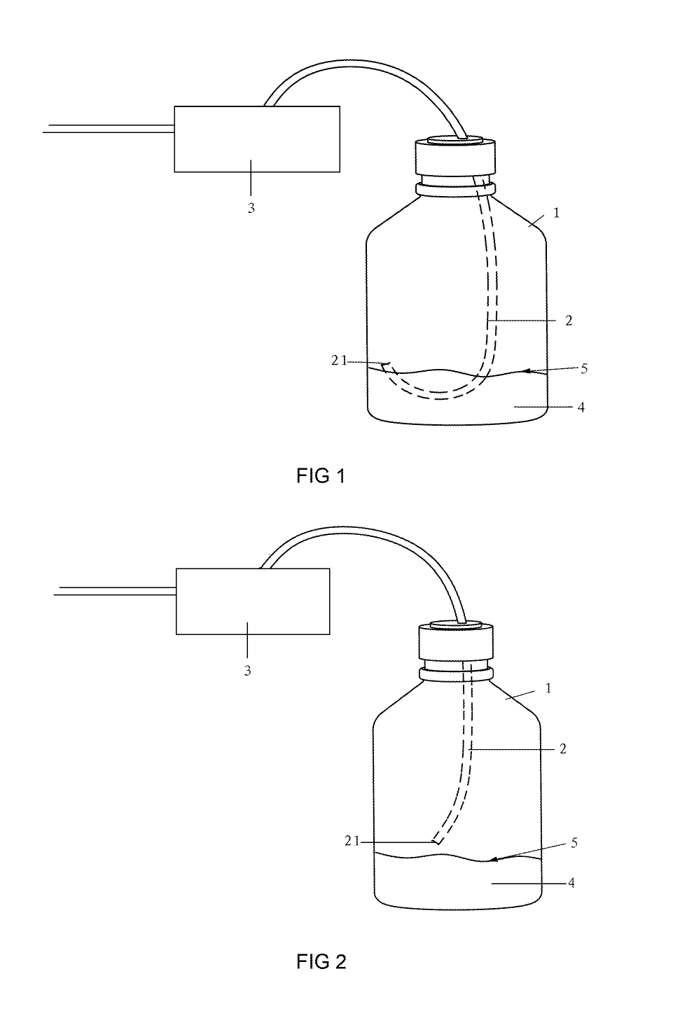

### DETAILED DESCRIPTION OF THE PREFERRED EMBODIMENTS

The following refers to drawings and embodiments to describe the present invention in details.

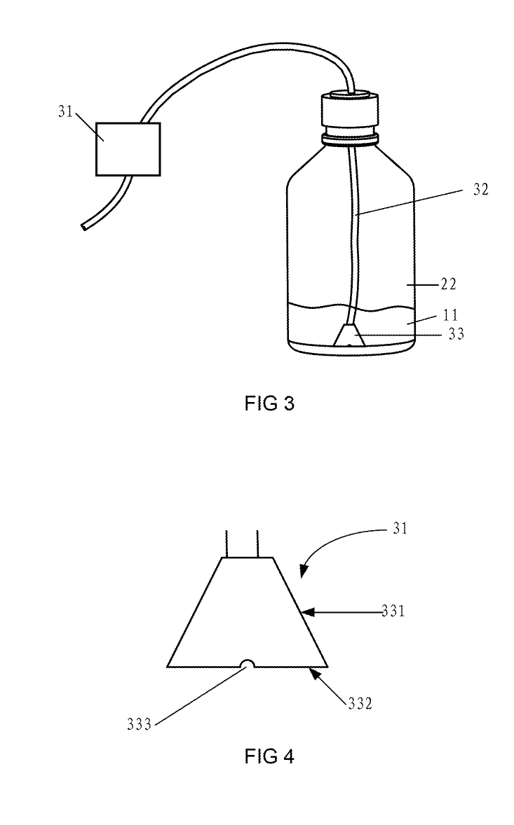

Referring to FIG. 3, FIG. 3 is a schematic view showing the structure of the first embodiment of the liquid crystal suction device according to the present invention. As shown in FIG. 3, the liquid crystal suction device according to the present invention comprises a first vacuum generation unit 31, a flexible suction tube 32 and a load 33; wherein load 33 is disposed at one end of flexible suction tube 32, and the other end of flexible suction tube 32 is connected to first vacuum generation unit 31.

Referring to FIG. 4 and FIG. 5, FIG. 4 is a schematic enlarged view showing load 33 of the first embodiment of the liquid crystal suction device according to the present invention; and FIG. 5 is a schematic view showing the load of FIG. 4 upside down. As shown in figures, load 33 can have a shape of cone, con base, or similar shape, and includes two intersecting surfaces 331, 332, that is, side and bottom of a cone or side and larger bottom of a cone base, respectively. Opening 321 of one end of flexible suction tube 32 is disposed on surface 332 of load 33, and surface 332 of load 33 has an opening groove 333. One end of opening groove 333 is connected to opening 321 of one end of flexible suction tube 32. The other end of opening groove 333 is connected to surface 331 of load 33. In actual application, two or more opening grooves 333 can be disposed, and not restriction is imposed here.

Opening 321 of one end of flexible suction tube 32 is disposed on surface 332 of load 33 corresponding to bottom of cone or cone base so that opening 321 of one end of flexible suction tube 32 always stays at lowest end of flexible suction tube 32 with higher stability. Because opening groove 333 on surface 332 is connected to opening 321 of one end of flexible suction tube 32 and surface 321 corresponding to side of cone or cone base respectively, opening 321 of one end of flexible suction tube 32 can always draws in liquid crystal when touching bottom 22 of container 22 containing liquid crystal 11, and not be sealed by touching surface 332 of load 33 and bottom 22 of container 22 containing liquid crystal.

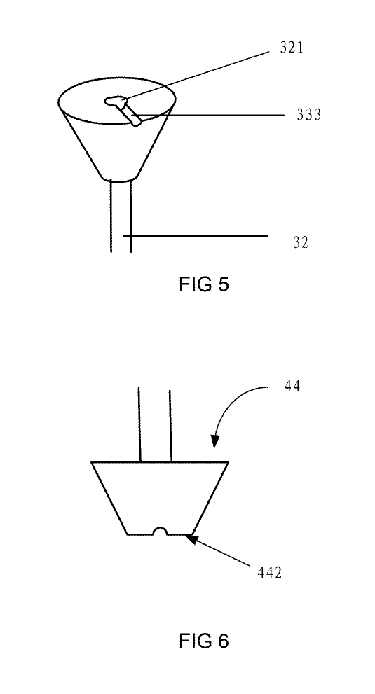

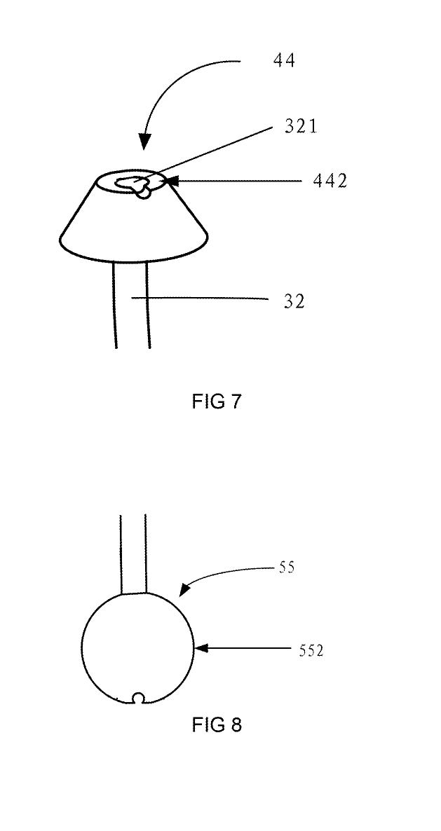

Referring to FIG. 6 and FIG. 7, FIG. 6 is a schematic enlarged view showing a reverse conic load of another embodiment of the liquid crystal suction device according to the present invention; and FIG. 7 is a schematic view showing the load of FIG. 6 upside down. Load 44 of FIG. 6 and FIG. 7 is similar to load 33 of FIG. 4 and FIG. 5, except that load 44 of FIG. 6 and FIG. 7 has a shape of reverse cone, reverse cone bone, or other similar shapes. In the instant embodiment, opening 321 of one end of flexible suction tube 32 is disposed on surface 442 of load 44 corresponding to top of cone or cone base.

The reverse cone, reverse cone base or other similar shapes can ensure opening 321 of one end of flexible suction tube 32 can reach to narrower part at bottom of liquid crystal container to suck the liquid crystal as exhausted as possible.

Referring to FIG. 8 and FIG. 9, FIG. 8 is a schematic enlarged view showing a spherical load of another embodiment of the liquid crystal suction device according to the present invention; and FIG. 9 is a schematic view showing the load of FIG. 8 upside down. Load 55 of FIG. 8 and FIG. 9 is similar to load 33 of FIG. 4 and FIG. 5, except that load 55 of FIG. 8 and FIG. 9 has a shape of sphere, or other similar shapes. In the instant embodiment, opening 321 of one end of flexible suction tube 32 is disposed on surface 552 of load 55.

Spherical load 55 can easily roll at bottom of liquid crystal container. Under gravity, load 55 can automatically reach the lowest position in container to such the liquid crystal as exhausted as possible.

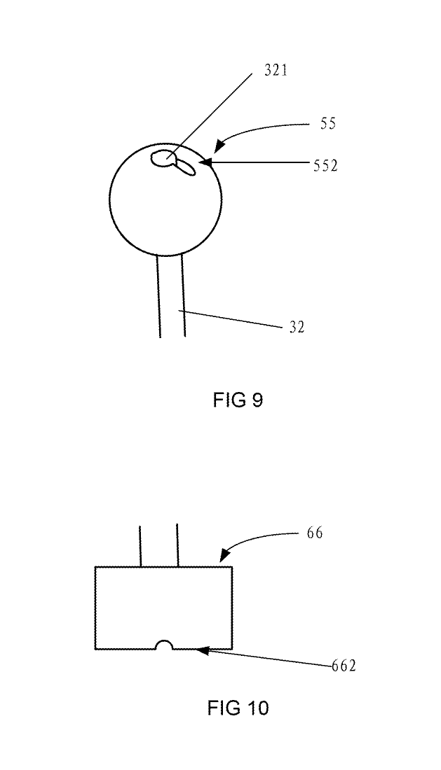

Referring to FIG. 10 and FIG. 11, FIG. 10 is a schematic enlarged view showing a cylindered load of another embodiment of the liquid crystal suction device according to the present invention; and FIG. 11 is a schematic view showing the load of FIG. 10 upside down. Load 66 of FIG. 10 and FIG. 11 is similar to load 33 of FIG. 4 and FIG. 5, except that load 66 of FIG. 10 and FIG. 11 has a shape of cylinder, or other similar shapes. In the instant embodiment, opening 321 of one end of flexible suction tube 32 is disposed on surface 662 of load 66.

The cylinder shape or other similar shapes can ensure opening 321 of one end of flexible suction tube 32 can reach to narrower part at bottom of liquid crystal container to suck the liquid crystal as exhausted as possible.

It is obvious that the shape of load can be designed to meet the actual requirements and no specific restriction is imposed here.

The load has surfaces made of glass or stainless steel. Alternatively, the load can be made entirely of glass or stainless. In actual application, the surfaces of the load must be made of material that will not pollute the liquid crystal, and other materials meeting this requirement can be used.

It should be understood that at the gravity pull of the load, flexible suction tube 32 can stay below the level of the liquid crystal to prevent flexible suction tube 32 from exposed above liquid crystal level and drawing in air so as to enable flexible suction tube 32 to suck in the liquid crystal at the bottom.

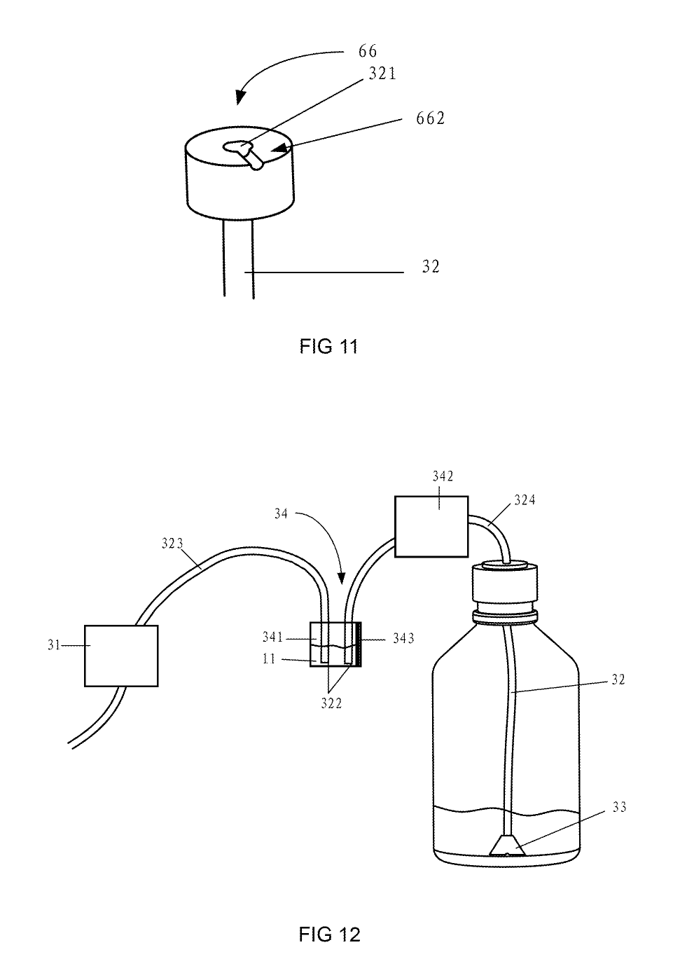

Referring to FIG. 12, FIG. 12 is a schematic view showing the structure of the second embodiment of the liquid crystal suction device according to the present invention. In the instant embodiment, the device comprises a first vacuum generation unit 31, a flexible suction tube 32, a load 33 and an air filter unit 34.

In the instant embodiment, load 33 is disposed at one end of flexible suction tube 32. The other end of flexible suction tube 32 is connected to first vacuum unit 31. Air filter unit 34 is disposed in tube passage of flexible suction tube 32, comprising liquid crystal container 341, second vacuum generation unit 342 and liquid level detection unit 343.

A part of flexible suction tube 32 is disposed through opening of container 341 into container 341, and the part disposed inside container 341 is cut so that flexible suction tube 32 is divided into a first suction tube part 323 connected to first vacuum generation unit 31 and a second suction tube part 324 connected to load 33. Second vacuum generation unit 342 is disposed at second suction tube part 324. Cut point of flexible suction tube 32 is immersed in liquid crystal 11 inside container 341.

When liquid level detection unit 343 detects liquid crystal 11 inside container 341 having a level lower than a first threshold, second vacuum generation unit 342 is made to draw liquid crystal into container 341. If the liquid crystal entering container 341 has air bubble, the air bubbles will rise above the liquid crystal level, instead of entering first suction tube part 323. In addition, when liquid level detection unit 343 detects liquid crystal 11 inside container 341 having a level reaching a second threshold, second vacuum generation unit 342 is made to stop drawing liquid crystal. The second threshold being higher than the first threshold.

Air filter unit 34 contains a very small amount of liquid crystal. Liquid level of the liquid crystal is controlled by level detection unit 343 so that liquid level immerses cut point 322 of flexible suction tube. Specific amount is determined by actual application, preferably not wasting any unnecessary amount. In addition, to prevent air bubble accidentally enters first suction tube part 323, first suction tube part 323 entering liquid crystal inside container 341 should be as away from second suction tube part 324 as possible.

Load 33 is any load of the first embodiment of the device.

It should be noted that air filter unit 34 is more effective to avoid the situation that flexible suction tube close to load may suck in air because amount of liquid crystal is small at the last few drops, and draws in the last drop of liquid crystal. In particular, when mass production, the wasted liquid crystal is those contained inside the air filler unit.

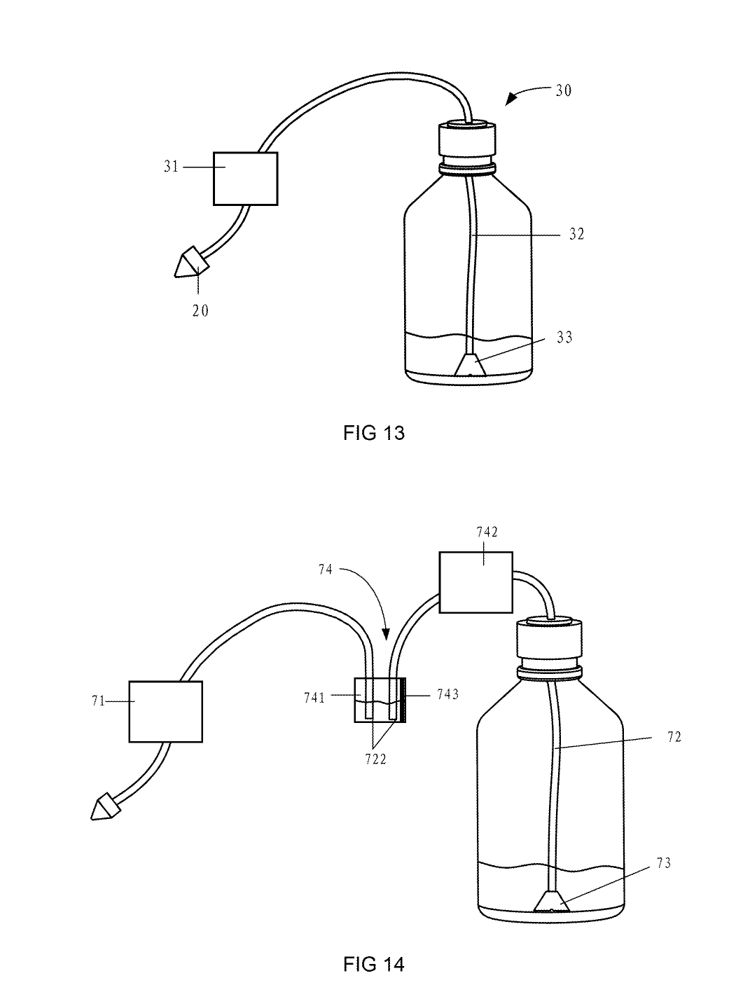

The present invention further provides a liquid crystal coating equipment, as shown in FIG. 13, which comprises: coating head 20 and liquid crystal suction device 30; wherein liquid crystal suction device 30 comprises: a first vacuum generation unit 31, a flexible suction tube 32, and a load 33; load 33 being disposed at one end of flexible suction tube 32, the other end of flexible suction tube 32 connected to first vacuum unit 31, coating head 20 connected to the first vacuum generation unit 31.

Refer to FIG. 4, and FIG. 5. Load 33 comprises two intersecting surfaces 331, 332. Opening 321 of one end of flexible suction tube 32 is disposed on surface 332 of load 33, and surface 332 of load 33 has an opening groove 333. One end of opening groove 333 is connected to opening 321 of one end of flexible suction tube 32. The other end of opening groove 333 is connected to surface 331 of load 33. In actual application, two or more opening grooves 333 can be disposed, and not restriction is imposed here.

Shape of load 33 can be sphere, cone, or cylinder, as shown in FIG. 4-11. It is obvious that the shape of load can be designed to meet the actual requirements and no specific restriction is imposed here.

The load has surfaces made of glass or stainless steel. Alternatively, the load can be made entirely of glass or stainless. In actual application, the surfaces of the load must be made of material that will not pollute the liquid crystal, and other materials meeting this requirement can be used.

Referring to FIG. 14, FIG. 14 is a schematic view showing the structure of the second embodiment of the liquid crystal coating equipment according to the present invention. Load 73 is disposed at one end of flexible suction tube 72, and the other end of flexible suction tube 72 is connected to first vacuum generation unit 71. Air filter unit 74 is disposed in tube passage of flexible suction tube 72, comprising liquid crystal container 741, second vacuum generation unit 742 and liquid level detection unit 743.

A part of flexible suction tube 72 is disposed through opening of container 741 into container 741, and the part disposed inside container 741 is cut so that flexible suction tube 72 is divided into a first suction tube part connected to first vacuum generation unit 71 and a second suction tube part connected to load 73. Second vacuum generation unit 742 is disposed at second suction tube part. Cut point 722 of flexible suction tube 72 is immersed in liquid crystal inside container.

When liquid level detection unit 743 detects liquid crystal inside container having a level lower than a first threshold, second vacuum generation unit 742 is made to draw liquid crystal into container. When liquid level detection unit 743 detects liquid crystal inside container having a level reaching a second threshold, second vacuum generation unit 742 is made to stop drawing liquid crystal. The second threshold being higher than the first threshold.

Air filter unit 74 contains a very small amount of liquid crystal. Liquid level of the liquid crystal is controlled by level detection unit 743 so that liquid level immerses cut point of flexible suction tube. Specific amount is determined by actual application, preferably not wasting any unnecessary amount.

Load 73 is any load of the first embodiment of the liquid crystal suction device.

It should be noted that air fitter unit 74 is more effective to avoid the situation that flexible suction tube 72 close to load 73 may suck in air because amount of liquid crystal is small at the last few drops, and draws in the last drop of liquid crystal. In particular, when mass production, the wasted liquid crystal is those contained inside air filter unit 74.

It should be noted that the load of the present embodiment can also be connected to flexible suction tube serially, with same thickness as flexible suction tube 72. The appearance of load is consistent with flexible suction tube 72. AT this point, the density is higher than flexible suction tube 72.

In summary, the embodiments of the present invention utilize a load disposed at one end of the flexible suction tube to keep one end of the flexible suction unit to say below the liquid crystal level. In this manner, the present invention prevents suction end of the liquid crystal tube from drawing in air bubble and keep each liquid crystal drop the same weight.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A liquid crystal suction device, which comprises:
a first vacuum generation unit, a flexible suction tube, a load, and an air filter unit;
wherein the load being disposed at one end of flexible suction tube, the other end of flexible suction tube connected to first vacuum unit; the air filter unit being disposed in tube passage of the flexible suction tube, comprising liquid crystal container, second vacuum generation unit and liquid level detection unit; a part of the flexible suction tube being disposed through container opening into container, and the part disposed inside the container being cut so that flexible suction tube being divided into a first suction tube part connected to the first vacuum generation unit and a second suction tube part connected to the load; the second vacuum generation unit being disposed at the second suction tube part, cut point of flexible suction tube being immersed in liquid crystal inside container, when the liquid level detection unit detecting liquid crystal inside the container having a level lower than a first threshold, the second vacuum generation unit being made to draw liquid crystal into container and stopping drawing liquid crystal when the liquid level detection unit detecting liquid crystal inside the container having a level reaching a second threshold, the second threshold being higher than the first threshold;
the load being an object with surface made of glass or stainless steel.

2. The liquid crystal suction device as claimed in claim 1, characterized in that the load further comprises two intersecting surfaces, with opening of one end of flexible suction tube disposed on one of surfaces of the load, and surface of the load having opening groove, one end of the opening groove connected to opening of one end of flexible suction tube, and other end of opening groove connected to the other surface of the load.

3. The liquid crystal suction device as claimed in claim 2, characterized in that shape of the load is a sphere, cone or cylinder.

4. A liquid crystal suction device, which comprises:
a first vacuum generation unit, a flexible suction tube, and a load;
wherein the load being disposed at one end of flexible suction tube, the other end of flexible suction tube connected to first vacuum unit.

5. The liquid crystal suction device as claimed in claim 4, characterized in that the load is an object with surface made of glass or stainless steel.

6. The liquid crystal suction device as claimed in claim 5, characterized in that the load further comprises two intersecting surfaces, with opening of one end of flexible suction tube disposed on one of surfaces of the load, and surface of the load having opening groove, one end of the opening groove connected to opening of one end of flexible suction tube, and other end of opening groove connected to the other surface of the load.

7. The liquid crystal suction device as claimed in claim 6, characterized in that shape of the load is a sphere, cone or cylinder.

8. The liquid crystal suction device as claimed in claim 4, characterized in that the liquid crystal suction device further comprises air filter unit, and the air filter unit being disposed in tube passage of the flexible suction tube, comprising liquid crystal container, second vacuum generation unit and liquid level detection unit; a part of the flexible suction tube being disposed through container opening into container, and the part disposed inside the container being cut so that flexible suction tube being divided into a first suction tube part connected to the first vacuum generation unit and a second suction tube part connected to the load; the second vacuum generation unit being disposed at the second suction tube part, cut point of flexible suction tube being immersed in liquid crystal inside container, when the liquid level detection unit detecting liquid crystal inside the container having a level lower than a first threshold, the second vacuum generation unit being made to draw liquid crystal into container and stopping drawing liquid crystal when the liquid level detection unit detecting liquid crystal inside the container having a level reaching a second threshold, the second threshold being higher than the first threshold.

9. A liquid crystal coating equipment, which comprises:
a coating head and a liquid crystal suction device;
wherein the liquid crystal suction device comprises: a first vacuum generation unit, a flexible suction tube, and a load; the load being disposed at one end of flexible suction tube, the other end of flexible suction tube connected to first vacuum unit, the coating head connected to the first vacuum generation unit.

10. The liquid crystal coating equipment as claimed in claim 9, characterized in that the load is an object with surface made of glass or stainless steel.

11. The liquid crystal coating equipment as claimed in claim 10, characterized in that the load further comprises two intersecting surfaces, with opening of one end of flexible suction tube disposed on one of surfaces of the load, and surface of the load having opening groove, one end of the opening groove connected to opening of one end of flexible suction tube, and other end of opening groove connected to the other surface of the load.

12. The liquid crystal coating equipment as claimed in claim 9, characterized in that shape of the load is a sphere, cone or cylinder.

13. The liquid crystal coating equipment as claimed in claim 9, characterized in that the liquid crystal suction device further comprises air filter unit, and the air filter unit being disposed in tube passage of the flexible suction tube, comprising liquid crystal container, second vacuum generation unit and liquid level detection unit; a part of the flexible suction tube being disposed through container opening into container, and the part disposed inside the container being cut so that flexible suction tube being divided into a first suction tube part connected to the first vacuum generation unit and a second suction tube part connected to the load; the second vacuum generation unit being disposed at the second suction tube part, cut point of flexible suction tube being immersed in liquid crystal inside container, when the liquid level detection unit detecting liquid crystal inside the container having a level lower than a first threshold, the second vacuum generation unit being made to draw liquid crystal into container and stopping drawing liquid crystal when the liquid level detection unit detecting liquid crystal inside the container having a level reaching a second threshold, the second threshold being higher than the first threshold.
